(19) United States
(12) Patent Application Publication
(10) Pub. No.: US 2024/0335339 A1
(43) Pub. Date: Oct. 10, 2024

(54) Patient Transport Apparatus With A Frame Assembly For Supporting A Patient Treatment Device

(71) Applicant: Stryker Corporation, Kalamazoo, MI (US)

(72) Inventors: Zahraa Bazzi, Dearborn, MI (US); Christopher Gentile, Sturgis, MI (US)

(73) Assignee: Stryker Corporation, Kalamazoo, MI (US)

(21) Appl. No.: 18/571,400

(22) PCT Filed: Jun. 27, 2022
(86) PCT No.: PCT/US2022/035075

§ 371 Date: Dec. 18, 2023

Related U.S. Application Data
(60) Provisional application No. 63/294,177, filed on Dec. 28, 2021.

(51) Int. Cl. A61G 5/00; A61G 1/04; A61G 5/10

(52) U.S. Cl. CPC A61G 5/006; A61G 1/04; A61G 5/10

(57) ABSTRACT

A patient transport apparatus for supporting a patient and a patient treatment device. The patient transport apparatus includes a seat assembly having a seat frame. A fowler assembly having a fowler frame is coupled to seat frame and is moveable relative to the seat assembly. The seat and fowler assemblies support the patient. A fowler actuator moves the fowler frame relative to the seat frame. A support frame assembly is coupled to the fowler frame. The support frame assembly includes a handle extending from the fowler frame and has a grasping portion spaced from the fowler frame. A mounting member is coupled to the handle. The mounting member defines a brace surface shaped for supporting the patient treatment device. The brace surface is spaced from a grasping portion of the handle to permit a user to grab the handle while supporting the patient treatment device.

### CROSS-REFERENCE TO RELATED APPLICATIONS

The subject patent application claims priority to, and all the benefits of, U.S. Provisional Patent Application No. 63/294,177, filed on Dec. 28, 2021, the entire contents of which are incorporated by reference herein.

### BACKGROUND

Patient support systems facilitate care of patients in a health care setting. Patient support systems comprise patient transport apparatuses such as, for example, hospital beds, stretchers, cots, tables, wheelchairs, chairs, stair chairs, and the like. Many conventional patient transport apparatuses, such as for example cots, generally include a base arranged for movement about floor surfaces, and a litter upon which a patient can be positioned or otherwise supported. Here, one or types of lift mechanisms may be employed to facilitate adjusting a vertical position of the litter relative to the base to, among other things, promote patient care, load the patient transport apparatus into an ambulance, and the like.

Conventional stair chairs (or “evacuation chairs”) are configured to facilitate transporting a seated patient up or down a flight of stairs, such as by employing tracks that allow for controlled descent down a staircase. Those having ordinary skill in the art will appreciate that, when used in connection with certain emergency medical services, stair chairs are typically realized as separate patient transport apparatuses from cots. Further, many conventional ambulances are configured to facilitate loading, securing, and transporting cots, but typically only employ storage space for stair chairs. Thus, in scenarios where a patient being transported via an ambulance on a cot must be transported up or down stairs using a stair chair, the patient sometimes has to be transferred between different patient transport apparatuses, such as from a stair chair to a cot which may subsequently be loaded into an ambulance.

It will be appreciated that transporting patients in stair chairs can sometimes necessitate that various types of emergency care equipment be transported concurrently with the patient up or down flights of stairs. Here, depending on the size, weight, and configuration of the emergency care equipment, it can be difficult for caregivers to navigate narrow stairwells while also simultaneously transporting the patient and the emergency care equipment.

A patient support system designed to overcome one or more of the aforementioned challenges is desired.

### SUMMARY

The present disclosure provides a patient transport apparatus for supporting a patient and a patient treatment device. The patient transport apparatus includes: a seat assembly having a front end and a rear end with a seat frame and defining a patient support surface for supporting the patient; a fowler assembly having a fowler frame coupled to a rear end of the seat frame and being moveable relative to the seat assembly, the fowler assembly further defining the patient support surface for supporting the patient, and the fowler assembly including a fowler actuator to move the fowler frame relative to the seat frame between a plurality of patient support configurations; and a support frame assembly coupled to the fowler frame and configured for supporting the patient treatment device, the support frame assembly including, a handle extending from the fowler frame and having a grasping portion spaced from the fowler frame, and a mounting member coupled to the handle adjacent the grasping portion of the handle and extending toward the fowler assembly, the mounting member defining a brace surface shaped for supporting the patient treatment device, the brace surface spaced from the grasping portion of the handle for permitting a user to grab the grasping portion while supporting the patient treatment device.

### BRIEF DESCRIPTION OF THE DRAWINGS

Advantages of the present disclosure will be readily appreciated as the same becomes better understood by reference to the following detailed description when considered in connection with the accompanying drawings.

FIG. 1A is a perspective view of a patient transport apparatus of a patient support system of the present disclosure, shown with the patient transport apparatus operating in an undocked mode with a base and supporting a patient treatment device.

FIG. 1B is another perspective view of the patient transport apparatus of FIG. 1A, shown with the patient transport apparatus operating in a docked mode with the litter secured to the base and supporting the patient treatment device.

FIG. 2 is a front perspective view of the litter of the patient transport apparatus of FIGS. 1A-1B supporting the patient treatment device.

FIG. 3 is a rear perspective view of the litter of the patient transport apparatus of FIGS. 1A-2 supporting the patient treatment device.

FIG. 4 is a partial rear perspective view of a frame assembly of the litter of the patient transport apparatus of FIGS. 1A-3 supporting the patient treatment device.

FIG. 5 is a partial rear perspective view of the frame assembly of the litter of the patient transport apparatus of FIGS. 1A-4.

FIG. 6 is a partial rear perspective view of the frame assembly of the litter of the patient transport apparatus of FIGS. 1A-5 partially exploded.

FIG. 7 is a rear elevation view of the frame assembly of the litter of the patient transport apparatus of FIGS. 1A-6.

FIG. 8 is a partial section view of the frame assembly of the litter of the patient transport apparatus of FIG. 7 taken along lines 8-8.

FIG. 9 is a side elevation view of the litter of the patient transport apparatus of FIGS. 1A-8.

### DETAILED DESCRIPTION

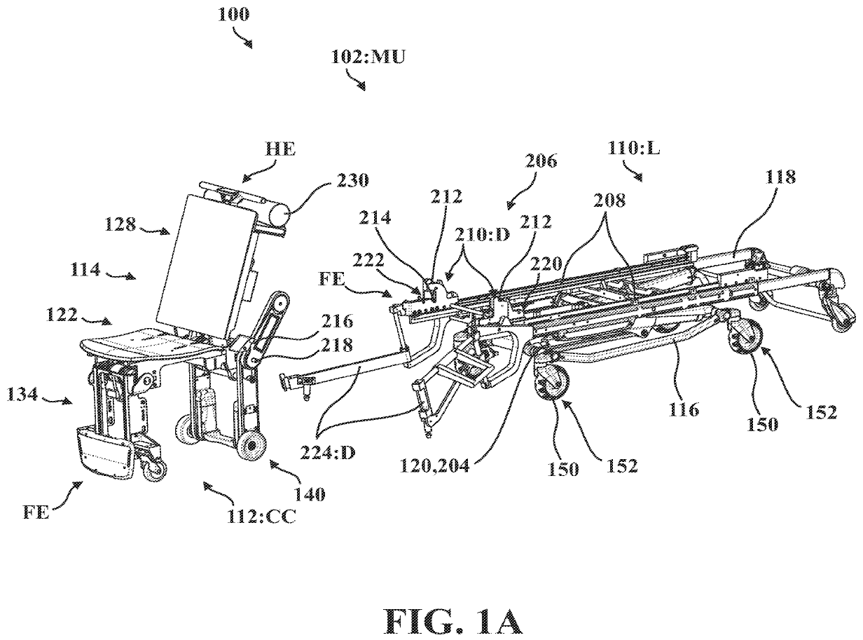

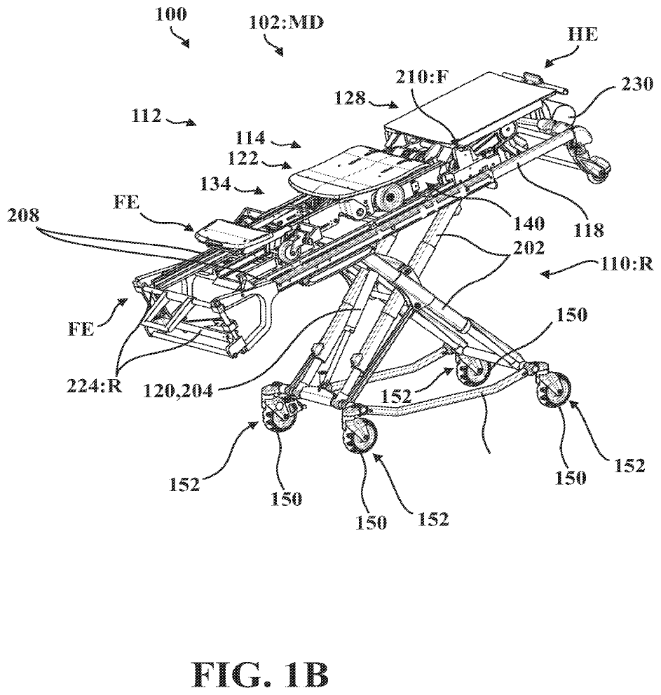

Referring to FIGS. 1A-1B, portions of a patient support system 100 are shown including a patient transport apparatus 102 for supporting a patient in a health care setting according to aspects of the present disclosure. In some versions, the patient transport apparatus 102 is configured to be loaded into a cargo area of an ambulance, such as via a power load device (not shown). As will be appreciated from the subsequent description below, while the illustrated versions of the patient transport apparatus 102 described herein are configured as cots for transporting patients, the patient transport apparatus 102 may comprise a hospital bed, a stretcher, a table, a wheelchair, a chair, or a similar apparatus utilized in the care of a patient. The version of the patient transport apparatus 102 shown in FIGS. 1A-1B generally comprises a base 110 and a litter 112. The litter 112 defines or otherwise comprises a patient support surface 114 to support a patient.

In some versions, the patient transport apparatus 102 may comprise a reconfigurable patient support as described in U.S. Pat. No. 9,486,373, which is hereby incorporated by reference in its entirety. In some versions, the patient transport apparatus 102 may comprise a reconfigurable transport apparatus as described in U.S. Pat. No. 9,510,981, which is hereby incorporated by reference in its entirety. In some versions, the patient transport apparatus 102 may comprise a person support apparatus system as described in U.S. Patent Application Publication No. 2018/0028383, which is hereby incorporated by reference in its entirety. In some versions, the patient transport apparatus 102 may comprise a patient transfer apparatus with integrated tracks as described in U.S. patent application Ser. No. 15/854,943, which is hereby incorporated by reference in its entirety. In some versions, the patient transport apparatus 102 may comprise a variable speed patient transfer apparatus as described in U.S. patent application Ser. No. 15/854,199, which is hereby incorporated by reference in its entirety. In some versions, the patient transport apparatus 102 may comprise a patient transfer apparatus as described in U.S. patent application Ser. No. 15/855,161, which is hereby incorporated by reference in its entirety. In some versions, the patient transport apparatus 102 may comprise an ambulance cot as described in U.S. Pat. No. 7,398,571, which is hereby incorporated by reference in its entirety.

With continued reference to FIGS. 1A-1B, the base 110 and litter 112 each have a head end HE and a foot end FE corresponding to designated placement of the patient's head and feet on the patient transport apparatus 102. In FIG. 1A, the litter 112 is shown separated from the base 110; as is described in greater detail below, the base 110 is configured to removably receive and support the litter 112 in certain situations. Put differently, in the illustrated version, the litter 112 is configured for releasable attachment to the base 110. The base 110 generally includes a base frame 116, an intermediate frame 118, and a base lift device 120. The intermediate frame 118 is spaced above the base frame 116 and is moved relative to the base frame 116 via the base lift device 120 as described in greater detail below. Although not illustrated in detail in the drawings, a mattress (or sections thereof) may be disposed on or integral with the litter 112. In such circumstances, the mattress comprises or otherwise defines a secondary patient support surface 114 upon which the patient is supported.

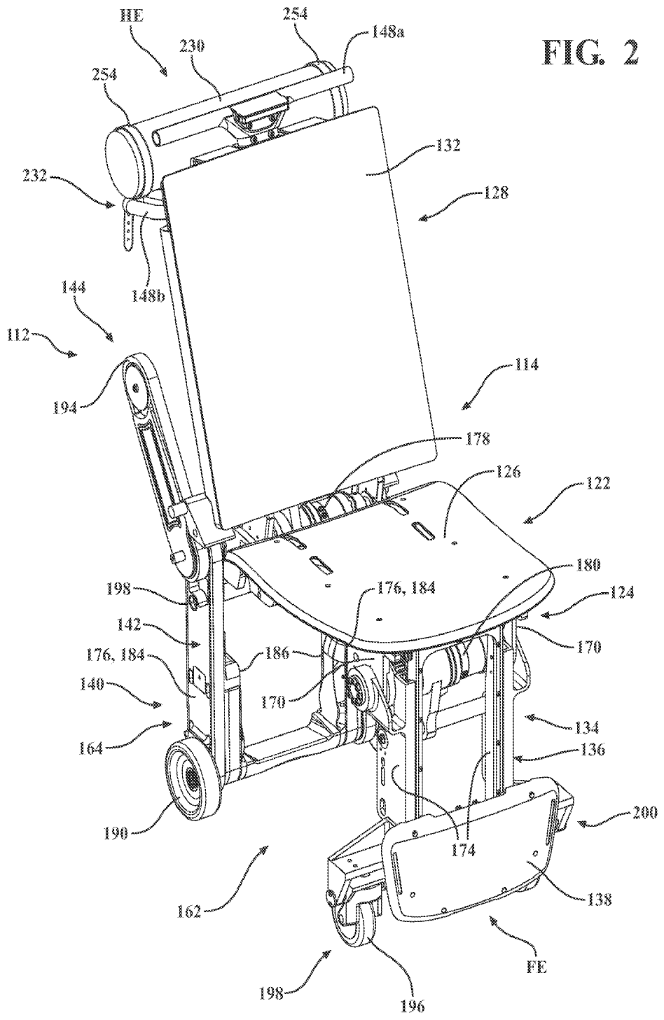

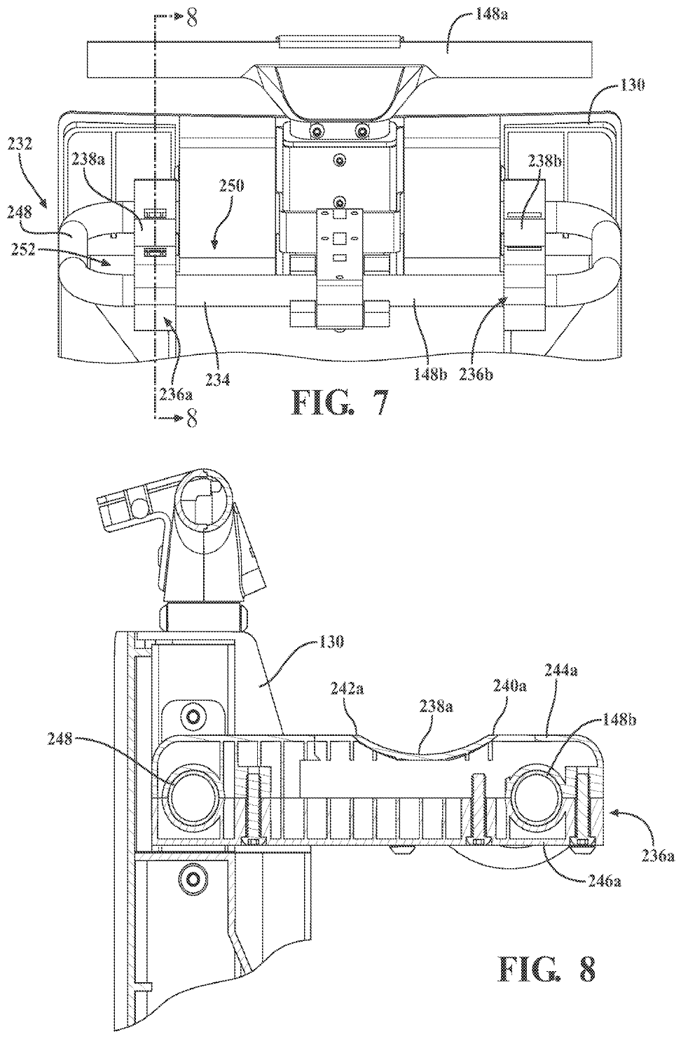

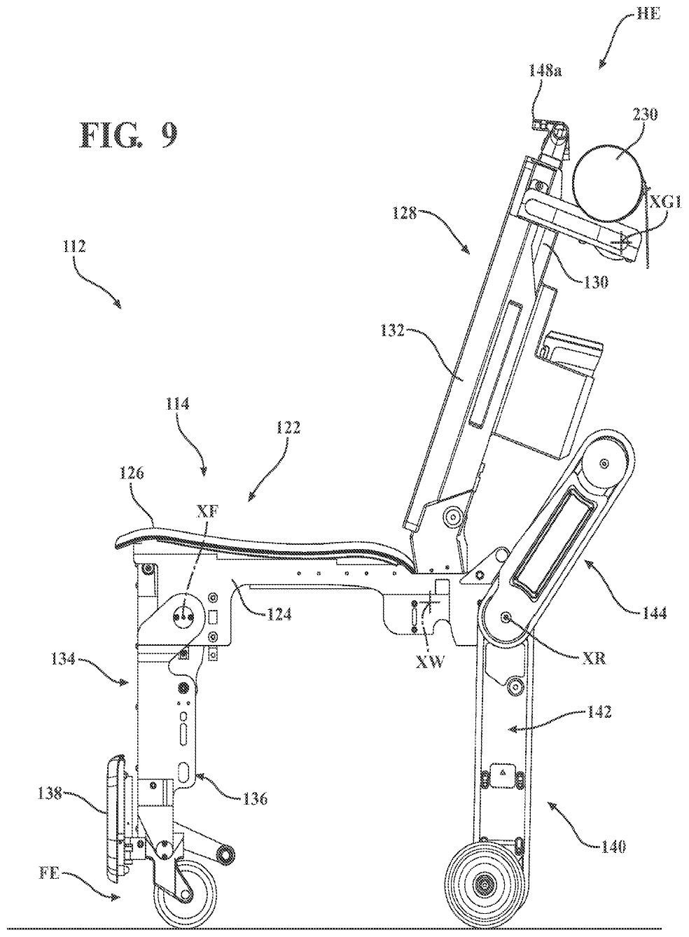

As will be described in greater detail below in connection with FIGS. 2-9, in the illustrated versions, the litter 112 employs a plurality of assemblies, some of which are capable of being articulated relative to others in various ways and under certain operating conditions to adjust the patient support surface 114 and to facilitate docking to and undocking from the base 110. In the illustrated version, the litter 112 generally includes a seat assembly 122 with a seat frame 124 and a seat section 126, a fowler assembly 128 with a fowler frame 130 and a fowler section 132, a front assembly 134 with a front frame 136 and a front section 138, a rear assembly 140 with a rear frame 142, and a ski assembly 144. Each of the assemblies 122, 128, 134, 140, 144 introduced above will be described in greater detail below.

In the illustrated versions, the fowler assembly 128 pivots relative to the seat assembly 122 about a fowler axis XW (shown in FIG. 10), the front assembly 134 pivots relative to the seat assembly 122 about a front axis XF, and the rear assembly 140 pivots relative to the seat assembly 122 about a rear axis XR. In addition, the ski assembly 144 pivots about the rear axis XR, but could pivot about other axes in some configurations. In the illustrated version, the seat section 126, the fowler section 132, and the front section 138 each provide support to the patient and, thus, generally cooperate to define the patient support surface 114. In the illustrated version, the front section 138 is also configured to translate along the front frame 136, such as is described in U.S. patent application Ser. No. 16/705,878, the disclosure of which is hereby incorporated by reference in its entirety. It will be appreciated that the fowler section 132 and the front section 138 may pivot relative to the seat section 126, or may articulate relative to the seat section 126 in any manner. For instance, the fowler section 132 and/or the front section 138 may both pivot and translate relative to the seat section 126 in some configurations.

Caregiver interfaces 148, such as upper and lower handles 148a, 148b, help facilitate movement of the patient transport apparatus 102 over floor surfaces. Here, caregiver interfaces 148 may be coupled to the fowler assembly 128, the front assembly 134 (not shown), the intermediate frame 118 (not shown), and the like. Additional caregiver interfaces may be integrated into other components of the patient transport apparatus 102. The upper and lower handles 148a, 148b and other optional caregiver interfaces 148 are graspable by the caregiver to manipulate the patient transport apparatus 102 for movement.

Base wheels 150 are coupled to the base frame 116 to facilitate transport over floor surfaces, and facilitate supporting the base. The base wheels 150 are arranged in each of four quadrants of the base 110 adjacent to corners of the base frame 116. In the illustrated versions, the base wheels 150 are caster wheels, which are able to rotate and swivel relative to the base frame 116 during transport. Each of the base wheels 150 forms part of a base caster assembly 152. Each base caster assembly 152 is mounted to the base frame 116. It should be understood that various configurations of base caster assemblies 152 are contemplated. In addition, in some configurations, the base wheels 150 are not caster wheels and may be non-steerable, steerable, non-powered, powered, or combinations thereof. Additional base wheels 150 are also contemplated. For example, the patient transport apparatus 102 may comprise four non-powered, non-steerable wheels, along with one or more powered wheels. In some cases, the patient transport apparatus 102 may not include any wheels. In other configurations, one or more auxiliary wheels (powered or non-powered), which are movable between stowed positions and deployed positions, may be coupled to the base frame 116. In some cases, when these auxiliary wheels are located between caster assemblies and contact the floor surface FS in the deployed position, they cause two of the base caster assemblies 152 to be lifted off the floor surface thereby shortening a wheel base of the patient transport apparatus 102. A fifth wheel may also be arranged substantially in a center of the base 110. Other configurations are contemplated.

It should be noted that in many of the drawings described herein, certain components of the patient transport apparatus 102 have been omitted from view for convenience of description and case of illustration.

A control system (not shown) of the patient transport apparatus may generally comprise one or more powered devices operated by a controller in response to actuation of one or more user interfaces and optionally in response to state signals from a sensing system (not shown). One suitable example of a patient transport apparatus 102 having such a control system is described in U.S. Patent Application Publication No. 2018/0369036, which is hereby incorporated by reference in its entirety.

The litter 112 of the present disclosure is configured to be removably attached to the intermediate frame 118 of the base 110, as noted above and as is described in greater detail below, and is generally operable between: an undocked mode MU (see FIG. 1A) where the litter 112 supports the patient for movement independent of the base 110, and a docked mode MD (see FIG. 1B) where the litter 112 supports the patient for movement concurrent with the base 110. While operating in the undocked mode MU, the litter 112 is operable between various configurations by pivoting or otherwise articulating assemblies 122, 128, 134, 140, 144 relative to one another. While operating in the docked mode MD, portions of the litter 112 may be articulable to adjust the patient support surface 114, such as by moving the fowler assembly 128.

In some configurations, the litter 112 is configured to serve as a mobile chair to transport the patient along floor surfaces FS as well as up and down stairs ST. Mobile chairs (sometimes called “stair chairs”) are used to evacuate patients from buildings where patient accessibility is limited, such as buildings having more than one floor. As noted above, the patient support surface 114 of the litter 112 of the illustrated patient transport apparatus 102 is generally defined by the fowler section 132, the seat section 126, and the front section 138. Here, the seat section 126 is supported by the seat frame 124, and the fowler section 132 is supported by the fowler frame 130 that is coupled to the seat frame 124 such that the fowler frame 130 may pivot or otherwise articulate relative to the seat frame 124. The front section 138 is supported by the front frame 136 which is coupled to the seat frame 124 such that the front frame 136 may pivot or otherwise articulate relative to the seat frame 124. Here too, the rear assembly 140 is coupled to the seat frame 124 such that the rear frame 142 may pivot or otherwise articulate relative to the seat frame 124.

In some configurations, the seat frame 124 may include seat frame members 170 spaced laterally apart from and fixed relative to each other. Similarly, the fowler frame 130 may include fowler frame members 172 spaced laterally apart and fixed relative to each other. The front frame 136 may include front legs 174 spaced laterally apart and fixed relative to each other, and the rear frame 142 may include rear legs 176 spaced laterally apart and fixed relative to each other. In the illustrated version, the litter 112 comprises a fowler actuator 178, a front actuator 180, and a rear actuator 182 which are each driven by the controller (e.g., by a litter controller) and are operatively attached to the seat assembly 122 to facilitate respectively pivoting or otherwise articulating the fowler assembly 128, the front assembly 134, and the rear assembly 140 relative to the seat assembly 122.

In the illustrated versions, the fowler assembly 128 is movable via the fowler actuator 178 between a fowler raised position, a fowler lowered position, and one or more intermediate fowler positions between the fowler raised position and the fowler lowered position.

As noted above, the illustrated patient transport apparatus 102 employs the track driving device 164, which is configured to assist users in traversing a flight of stairs by mitigating the load users (e.g., caregivers) would otherwise be required to lift via caregiver interfaces 148. In some configurations, the track driving device 164 may be configured to move the litter 112 across the floor surface. The track driving device 164 is formed as a part of the rear legs 176 of the rear assembly 140. Here, each rear leg 176 includes a respective track frame member 184 coupled to the seat frame 124 for pivoting movement about the rear axis XR. The track driving device 164 also includes track actuators 186 which drive continuous leg tracks 188 rotatably coupled to the respective leg track frame members 184. The track actuators 186 are coupled to the track frame members 184 and are coupled to (or otherwise disposed in communication with) the controller to drive the leg tracks 188 for ascending and descending stairs. The track driving device 164 may be configured to operate in the same manner or a similar manner as those shown in U.S. Pat. Nos. 7,398,571, 9,486,373, 9,510,981, U.S. 2018/0369036 and/or U.S. Patent Application Publication No. 2018/0028383, previously referenced.

The rear assembly 140 also includes rear wheels 190 rotatably coupled to each of the track frame members 184 that are configured to be disposed in contact with the floor surface FS, such as to support the litter 112 for movement in the chair configuration CC. In the illustrated versions, the rear wheels 190 are freely rotatable. In alternative versions, the rear wheels 190 may be powered drive wheels coupled to the controller. Other configurations are contemplated. The components of the track driving device 164 are arranged such that the leg track frame members 184, the leg tracks 188, and the rear wheels 190 move together with the rear assembly 140 which, as noted above, is arranged to selectively pivot about the rear axis XR to facilitate changing between the various configurations of the litter 112 as well as to facilitate docking and undocking from the base 110.

In some versions, the ski assemblies 144 serve as extensions to the track driving device 164 and likewise help facilitate engagement with stairs ST. To this end, in the illustrated versions, the ski assemblies 144 each include respective ski track frame members 192 operatively attached to the seat frame 124 for pivoting movement about the rear axis XR (or another axis). Here too, the track actuators 186 drive continuous ski tracks 194 rotatably coupled to the respective ski track frame members 192.

The front legs 174 of the front assembly 134 support respective front wheels 196, which are realized as part of respective front caster assemblies 198 arranged to facilitate movement of the litter 112 on the floor surface, as well as to facilitate transitioning between various litter 112 configurations. In the illustrated versions, the front wheels 196 are freely rotatable, but could be motorized, braked, and the like in some versions. As noted above, in some versions, the front section 138 may be translatable along the front frame 136. To this end, the front assembly 134 may include an extension mechanism, generally indicated at 200, configured to longitudinally position the front section 138 relative to the front legs 174. While not depicted in detail herein, the extension mechanism 200 may be similar to as is described in U.S. patent application Ser. No. 16/705,878, the disclosure of which is incorporated by reference in its entirety.

A litter lift device 162 is coupled to the litter 112 and is configured to raise and lower the patient between minimum and maximum heights of the litter 112, and to generally facilitate movement between litter 112 configurations when the litter 112 is separated from the base 110. To this end, the illustrated litter lift device 162 generally includes the front actuator 180 and the rear actuator 182. The base lift device 120 is coupled to the base 110 and is configured to raise and lower the patient between a plurality of vertical configurations including a maximum raised configuration 110R (see FIG. 1B), a maximum lowered configuration 110L (see FIG. 1A), and a plurality of vertical configurations therebetween, both while the litter 112 is supported by the base 110 and, in some versions, while the litter 112 is undocked from the base 110.

In the representative version illustrated in FIGS. 1A-1B, the base 110 comprises one or more lift arms 202 coupling the intermediate frame 118 to the base frame 116. The base lift device 120 comprises one or more base lift actuators 204 coupled to at least one of the base frame 116 and the intermediate frame 118 to raise and lower the intermediate frame 118 and litter 112 relative to the floor surface FS and the base frame 116. The base lift device 120 may be configured to operate in the same manner or a similar manner as the lift mechanisms shown in U.S. Pat. Nos. 7,398,571, 9,486,373, 9,510,981, and/or U.S. Patent Application Publication No. 2018/0028383, previously referenced.

The base 110 of the patient transport apparatus 102 also generally includes a docking subassembly 206 operatively coupled to the intermediate frame 118. Here, the docking subassembly 206 includes intermediate rails 208 which support a trolley 210 for translation between a trolley forward position 210F where the trolley 210 is arranged at the head end HE of the base 110, and a trolley docking position 210D where the trolley 210 is arranged at the foot end FE of the base 110. The trolley 210 includes or otherwise defines upper and lower pin stops 212, 214 which are arranged to engage against respective upper and lower pins 216, 218 of the litter 112 in order to support the litter 112 in a cantilevered position CP during the process of docking the litter 112 to the base 110, as well as to support the litter 112 to the base 110 when operating in the docked mode MD. The docking subassembly 206 also generally includes a forward trolley lock mechanism 220 to inhibit movement of the trolley 210 away from the trolley forward position 210F, and a dock trolley lock mechanism 222 to inhibit movement of the trolley 210 away from the trolley docking position 210D, in order to facilitate transitioning between the undocked mode MU and the docked mode MD.

As noted above, caregivers may use the litter 112 to evacuate patients from buildings where patient accessibility is limited, such as buildings having more than one floor. Evacuation of the patient is often accomplished outside the confines of a patient care facility. In these circumstances, caregivers may need to bring patient treatment devices 230 necessary to facilitate evacuation with them inside the building and keep the patient treatment devices close to the patient during evacuation. The patient treatment device 230 is realized as an Oxygen tank in this disclosure. However, it is contemplated that other patient treatment devices 230 may be employed. Requiring a caregiver to carry the patient treatment device 230 while simultaneously operating the litter 112 to evacuate the patient from the building can be cumbersome. To case this burden, the patient transport apparatus 102 includes a support frame assembly 232 to secure the patient treatment device 230 to the litter 112.

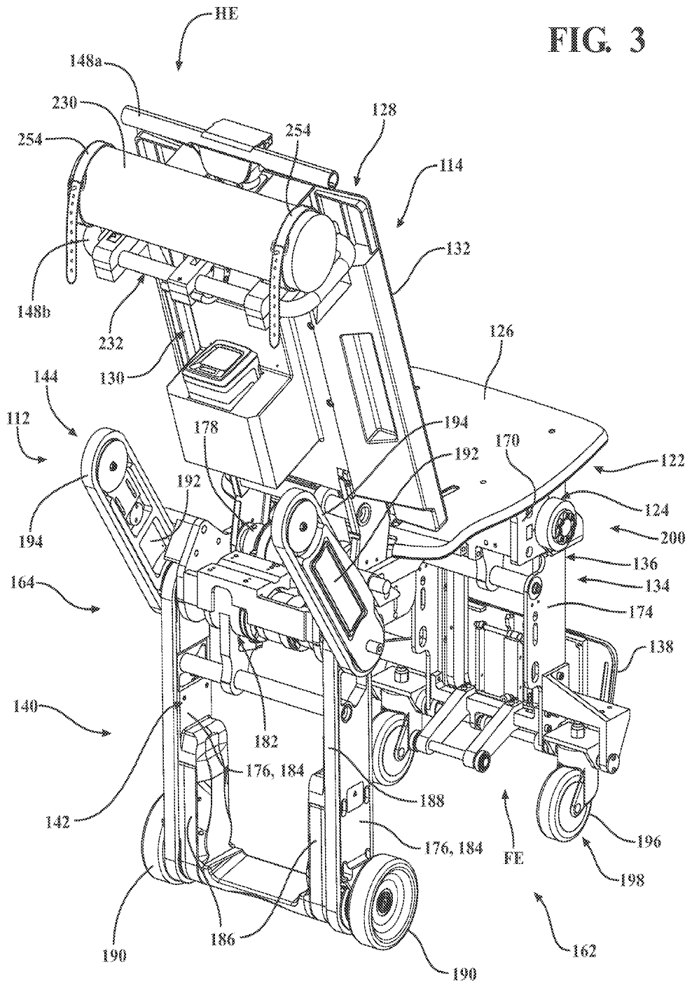

As shown in FIGS. 3-7, the support frame assembly 232 is coupled to the fowler frame 130. The support frame assembly 232 includes a handle (lower handle 148b). As noted above, the illustrated versions of the litter 112 include the upper handle 148a and the lower handle 148b as caregiver interfaces. In this version, the handle of the support frame assembly 232 comprises the lower handle 148b. It is contemplated that the support frame assembly 232 may include another handle or a different handle. The lower handle 148b extends from the fowler frame 130. The lower handle 148b has a grasping portion 234 spaced from the fowler frame 130 designed for the caregiver to grasp.

The support frame assembly 232 also includes a mounting member 236 coupled to the lower handle 148b adjacent the grasping portion 234 of the lower handle 148b. The mounting member 236 extends toward the fowler assembly 128. The mounting member 236 defines a brace surface 238 shaped for supporting the patient treatment device (e.g., the oxygen tank). The brace surface 238 is spaced from the grasping portion 234 of the lower handle 148b for permitting the caregiver to grab the grasping portion 234 while supporting the patient treatment device (FIG. 4).

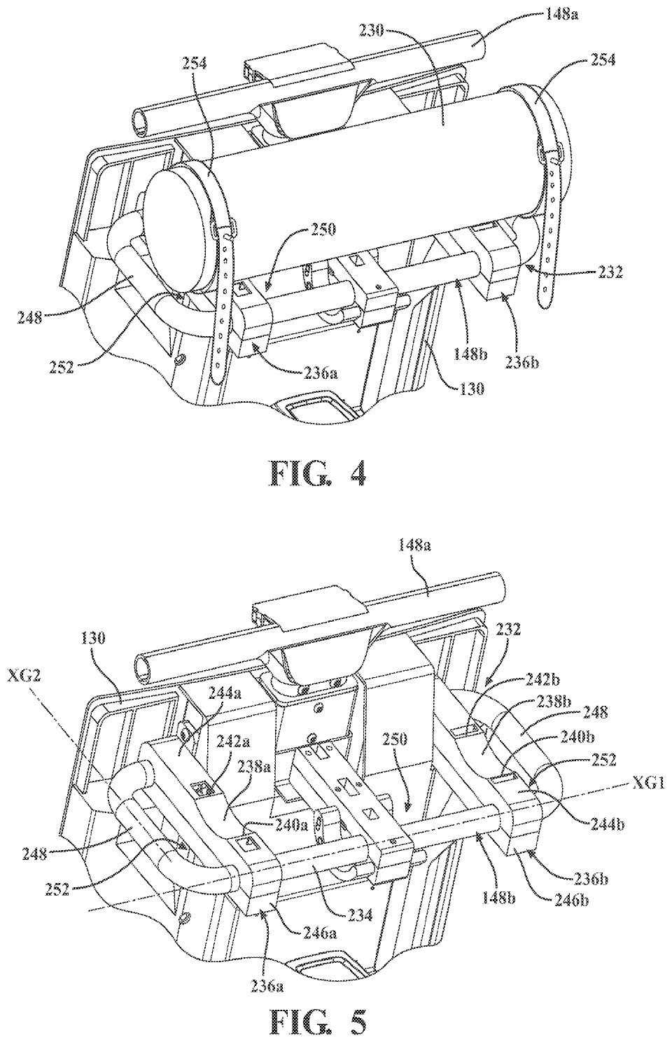

As shown in FIGS. 5-8, the mounting member 236 may have a first brace edge 240 proximal the grasping portion 234 of the lower handle 148b defining a first end of the brace surface 238. The mounting member 236 may have a second brace edge 242 distal the grasping portion 234 of the lower handle 148b defining a second end of the brace surface 238. One or more of the first and second brace edges 240, 242 may be linear and laterally disposed as illustrated such that the brace edges 240, 242 are parallel with the grasping portion 234 of the lower handle 148b. In other configurations, the brace edges 240, 242 may be non-linear. A first distance defined between the first brace edge 240 and the grasping portion 234 of the lower handle 148b may be less than a second distance defined between the second brace edge 242 and the fowler frame 130. In some configurations, the second distance may be at least twice as long as the first distance. In the illustrated configurations, the brace surface 238 defines a recess for receiving the patient treatment device. In other configurations, the mounting member 236 may have one or more projections extending outwardly instead of the recess. In such a configuration, the brace surface 238 may be an externally facing surface of the projection. In the illustrated configurations, the recess is “D-shaped” to maximize contact surface area with the patient treatment device 230 and accommodate a patient treatment device 230 having a cylindrical shape. It is contemplated that the recess (or projection in alternative configurations) may have another shape suitable for engaging and supporting the patient treatment device 230. In still other configurations, the brace surface 238 may be flat.

The mounting member 236 may be further defined as a first mounting member 236a and the support frame assembly 232 may further comprise a second mounting member 236b spaced from the first mounting member 236a. The second mounting member 236b may also be coupled to the lower handle 148b adjacent the grasping portion 234 of the lower handle 148b such that the grasping portion 234 is disposed between the first and second mounting members 236a, 236b. The second mounting member 236b may extend toward the fowler assembly 128 and define a second brace surface 238b shaped for supporting the patient treatment device 230. The second mounting member 236b may be identical to or different from the first mounting member 236a.

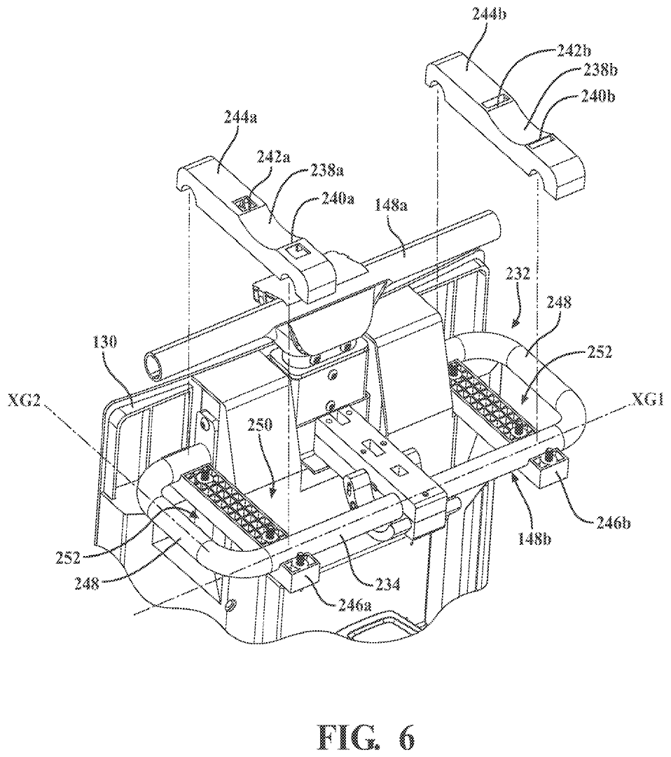

In some configurations, as shown in FIG. 6, the mounting members 236a, 236b may be selectively removable from the lower handle 148b. While the illustrated configurations depict the support frame assembly 232 having the first and second mounting members 236a, 236b, the first mounting member 236a is described below. It is contemplated that the second mounting member 236b may have one or more features in common with the first mounting member 236a. The mounting member 236a may comprise a first mounting body 244 and a second mounting body 246. The first and second mounting bodies 244, 246 may be configured to be coupled to each other to secure the mounting member 236a to the lower handle 148b adjacent the grasping portion 234 of the lower handle 148b. One of the first and second mounting bodies 244, 246 may comprise the brace surface 238. More specifically, the lower handle 148b may be disposed between the first and second mounting bodies 244, 246 when the first and second mounting bodies 244, 246 are coupled to each other. Said differently, the mounting bodies 244, 246 may “clam shell” or “sandwich” the lower handle 148b between each other to couple the mounting member 236 to the lower handle 148b. Although the first and second mounting bodies 244, 246 are shown coupled together via fasteners, it is contemplated that the mounting bodies 244, 246 may be coupled together in another manner.

In many configurations, as illustrated in FIG. 6, the lower handle 148b may comprise a “C” shape with the middle portion of the “C” including the grasping portion 234 and at least one mounting portion 248 extending between the grasping portion 234 and the fowler frame 130. In some configurations, as illustrated, the mounting member 236a may be coupled to the lower handle 148b at both the grasping portion 234 and the mounting portion 248 to provide greater rigidity. In some configurations, the grasping portion 234 may be further defined as a first grasping portion 234 and at least part of the mounting portion 248 of the lower handle 148b may be referred to as a second grasping portion 248 for the caregiver to grab. The mounting member 236a may separate the first grasping portion 234 from the second grasping portion 248. More specifically, a first grasping cavity 250 may be defined between the first grasping portion 234 and the fowler frame 130. In configurations of the support frame assembly 232 having two mounting members 236a, 236b, the first grasping cavity 250 may be further defined between the first and second mounting members 236a, 236b. A second grasping cavity 252 may be defined between the second grasping portion 248 and the mounting member 236a.

The first grasping portion 234 of the lower handle 148b may extend along a first grasping axis XG1. The first grasping axis XG1 may be parallel to the fowler axis XW. The mounting member 236a may extend perpendicularly relative to the first grasping axis XG1 such that the patient treatment device 230 may be disposed across the mounting member 236a, parallel to the first grasping portion 234. The second grasping portion 248 may extend along a second grasping axis XG2 perpendicular to the first grasping axis XG1.

The support frame assembly 232 may further comprise one or more straps 254 for securing the patient treatment device 230 to the mounting member 236a. The one or more straps 254 may comprise a rubber material, a silicone material, or another material suitable for securing the patient treatment device 230 to the mounting member 236a. Rubber or silicone straps are advantageous for securing patient treatment devices 230 having a metal exterior because the rubber or silicone straps may grip the patient treatment device 230. The one or more straps 254 may be attached to the mounting member 236a or the lower handle 148b.

It will be further appreciated that the terms “include,” “includes,” and “including” have the same meaning as the terms “comprise.” “comprises,” and “comprising.” Moreover, it will be appreciated that terms such as “first,” “second,” “third,” and the like are used herein to differentiate certain structural features and components for the non-limiting, illustrative purposes of clarity and consistency.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient transport apparatus for supporting a patient and a patient treatment device, the patient transport apparatus comprising:
a seat assembly having a front end and a rear end with a seat frame and defining a patient support surface for supporting the patient;
a fowler assembly having a fowler frame coupled to a rear end of the seat frame and being moveable relative to the seat assembly, the fowler assembly further defining the patient support surface for supporting the patient, and the fowler assembly including a fowler actuator to move the fowler frame relative to the seat frame between a plurality of patient support configurations; and
a support frame assembly coupled to the fowler frame and configured for supporting the patient treatment device, the support frame assembly including,
   a handle extending from the fowler frame and having a grasping portion spaced from the fowler frame, and
   a mounting member coupled to the handle adjacent the grasping portion of the handle and extending toward the fowler assembly, the mounting member defining a brace surface shaped for supporting the patient treatment device, the brace surface spaced from the grasping portion of the handle for permitting a user to grab the grasping portion while supporting the patient treatment device.

II. The patient transport apparatus of clause I, wherein the mounting member has a first brace edge proximal the grasping portion of the handle defining a first end of the brace surface, and wherein the mounting member as a second brace edge distal the grasping portion of the handle defining a second end of the brace surface.

III. The patient transport apparatus of clause II, wherein a first distance defined between the first brace edge and the grasping portion of the handle is less than a second distance defined between the second brace edge and the fowler frame.

IV. The patient transport apparatus of clause III, wherein the second distance is at least twice as long as the first distance.

V. The patient transport apparatus of any of clauses I-IV, wherein the brace surface defines a recess.

VI. The patient transport apparatus of clause V, wherein the recess has a D-shaped profile.

VII. The patient transport apparatus of any of clauses I-VI, wherein the mounting member is further defined as a first mounting member and the support frame assembly further comprises a second mounting member spaced from the first mounting member and coupled to the handle adjacent the grasping portion of the handle and extending toward the fowler assembly, the second mounting member defining a second brace surface shaped for supporting the patient treatment device, the second brace surface spaced from the grasping portion of the handle for permitting a user to grab the grasping portion while supporting the patient treatment device.

VIII. The patient transport apparatus of any of clauses I-VII, wherein the grasping portion of the handle extends along a grasping axis and wherein the mounting member extends perpendicularly from the grasping axis.

IX. The patient transport apparatus of any of clauses I-VIII, wherein the support frame assembly further comprises one or more straps for securing the patient treatment device to the mounting member.

X. The patient transport apparatus of clause IX, wherein the one or more straps comprise at least one material selected from rubber and silicone.

XI. The patient transport apparatus of any of clauses IX-X, wherein the one or more straps are attached to at least one of the mounting member and the handle.

XII. The patient transport apparatus of clauses I-XI, wherein the mounting member is selectively removable from the handle.

XIII. The patient transport apparatus of clause XII, wherein the mounting member comprises a first mounting body and a second mounting body, and wherein the first and second mounting bodies are configured to be coupled to each other to secure the mounting member adjacent the grasping portion of the handle.

XIV. The patient transport apparatus of clause XIII, wherein the handle is disposed between the first and second mounting bodies when the first and second mounting bodies are coupled to each other.

XV. The patient transport apparatus of any of clauses XIII-XIV, wherein one of the first and second mounting bodies defines the brace surface.

XVI. The patient transport apparatus of any of clauses I-XV, wherein the grasping portion of the handle is further defined as a first grasping portion of the handle, and wherein the handle includes a second grasping portion disposed between the first grasping portion and the fowler frame.

XVII. The patient transport apparatus of clause XVI, wherein the mounting member separates the first grasping portion from the second grasping portion, and wherein a first grasping cavity is defined between the first grasping portion of the handle and the fowler frame, and wherein a second grasping cavity is defined between the second grasping portion of the handle and the mounting member.

XVIII. The patient transport apparatus of any of clauses XVI-XVII, wherein the first grasping portion of the handle extends along a first grasping axis, and wherein the second grasping portion extends along a second grasping axis perpendicular to the first grasping axis.

XIX. The patient transport apparatus of any of clauses I-XVIII, wherein the fowler frame is rotatable relative to the seat frame about a fowler axis, and wherein the grasping portion of the handle extends along a grasping axis parallel to the fowler axis.

XX. The patient transport apparatus of any of clauses I-XIX, further comprising:
a front assembly coupled to the front end of the seat frame and configured for movement between a plurality of front assembly positions; and
a rear assembly coupled to the rear end of the seat frame and configured for movement between a plurality of rear assembly positions.

XXI. The patient transport apparatus of clause XX, further comprising:
a front actuator arranged to articulate the front assembly relative to the seat frame between the plurality of front assembly positions; and
a rear actuator arranged to articulate the rear assembly relative to the seat frame between the plurality of rear assembly positions.

XXII. The patient transport apparatus of any of clauses I-XXI, wherein at least part of one or more of the seat assembly, the fowler assembly, and the support frame assembly defines a litter.

XXIII. The patient transport apparatus of clause XXII, further comprising:
a base having a head end and a foot end, the base including:
a base frame supporting a plurality of wheels arranged for movement about a floor surface,
an intermediate frame having a trolley configured to translate between a plurality of trolley positions including a trolley forward position where the trolley is arranged at the head end of the base and a trolley docking position where the trolley is arranged at the foot end of the base, and
a base lift device to move the intermediate frame relative to the base frame between a plurality of vertical configurations including a maximum raised configuration and a maximum lowered configuration,
wherein the litter is configured to be docked to and undocked from the trolley of the intermediate frame such that, when docked to the trolley, the litter is configured to slidably translate relative to the intermediate frame between a plurality of litter positions to facilitate docking and undocking the litter from the trolley.

1. A patient transport apparatus for supporting a patient and a patient treatment device, the patient transport apparatus comprising:
a seat assembly having a front end and a rear end with a seat frame and defining a patient support surface for supporting the patient;
a fowler assembly having a fowler frame coupled to a rear end of the seat frame and being moveable relative to the seat assembly, the fowler assembly further defining the patient support surface for supporting the patient, and the fowler assembly including a fowler actuator to move the fowler frame relative to the seat frame between a plurality of patient support configurations; and
a support frame assembly coupled to the fowler frame and configured for supporting the patient treatment device, the support frame assembly including,
a handle extending from the fowler frame and having a grasping portion spaced from the fowler frame, and
a mounting member coupled to the handle adjacent the grasping portion of the handle and extending toward the fowler assembly, the mounting member defining a brace surface shaped for supporting the patient treatment device, the brace surface spaced from the grasping portion of the handle for permitting a user to grab the grasping portion while supporting the patient treatment device.

2. The patient transport apparatus of claim 1, wherein the mounting member has a first brace edge proximal the grasping portion of the handle defining a first end of the brace surface, and wherein the mounting member as a second brace edge distal the grasping portion of the handle defining a second end of the brace surface.

3. The patient transport apparatus of claim 2, wherein a first distance defined between the first brace edge and the grasping portion of the handle is less than a second distance defined between the second brace edge and the fowler frame.

4. The patient transport apparatus of claim 3, wherein the second distance is at least twice as long as the first distance.

5. The patient transport apparatus of claim 1, wherein the brace surface defines a recess.

6. (canceled)

7. The patient transport apparatus of claim 1, wherein the mounting member is further defined as a first mounting member and the support frame assembly further comprises a second mounting member spaced from the first mounting member and coupled to the handle adjacent the grasping portion of the handle and extending toward the fowler assembly, the second mounting member defining a second brace surface shaped for supporting the patient treatment device, the second brace surface spaced from the grasping portion of the handle for permitting a user to grab the grasping portion while supporting the patient treatment device.

8. The patient transport apparatus of claim 1, wherein the grasping portion of the handle extends along a grasping axis and wherein the mounting member extends perpendicularly from the grasping axis.

9. The patient transport apparatus of claim 1, wherein the support frame assembly further comprises one or more straps for securing the patient treatment device to the mounting member.

10. The patient transport apparatus of claim 9, wherein the one or more straps comprise at least one material selected from rubber and silicone.

11. The patient transport apparatus of claim 9, wherein the one or more straps are attached to at least one of the mounting member and the handle.

12. The patient transport apparatus of claim 1, wherein the mounting member is selectively removable from the handle.

13. The patient transport apparatus of claim 12, wherein the mounting member comprises a first mounting body and a second mounting body, and wherein the first and second mounting bodies are configured to be coupled to each other to secure the mounting member adjacent the grasping portion of the handle.

14. The patient transport apparatus of claim 13, wherein the handle is disposed between the first and second mounting bodies when the first and second mounting bodies are coupled to each other.

15. The patient transport apparatus of claim 13, wherein one of the first and second mounting bodies defines the brace surface.

16. The patient transport apparatus of claim 1, wherein the grasping portion of the handle is further defined as a first grasping portion of the handle, and wherein the handle includes a second grasping portion disposed between the first grasping portion and the fowler frame.

17. The patient transport apparatus of claim 16, wherein the mounting member separates the first grasping portion from the second grasping portion, and wherein a first grasping cavity is defined between the first grasping portion of the handle and the fowler frame, and wherein a second grasping cavity is defined between the second grasping portion of the handle and the mounting member.

18. The patient transport apparatus of claim 16, wherein the first grasping portion of the handle extends along a first grasping axis, and wherein the second grasping portion extends along a second grasping axis perpendicular to the first grasping axis.

19. The patient transport apparatus of claim 1, wherein the fowler frame is rotatable relative to the seat frame about a fowler axis, and wherein the grasping portion of the handle extends along a grasping axis parallel to the fowler axis.

20. The patient transport apparatus of claim 1, further comprising:
a front assembly coupled to the front end of the seat frame and configured for movement between a plurality of front assembly positions;
a rear assembly coupled to the rear end of the seat frame and configured for movement between a plurality of rear assembly positions;
a front actuator arranged to articulate the front assembly relative to the seat frame between the plurality of front assembly positions; and
a rear actuator arranged to articulate the rear assembly relative to the seat frame between the plurality of rear assembly positions.

21. (canceled)

22. The patient transport apparatus of claim 1, wherein at least part of one or more of the seat assembly, the fowler assembly, and the support frame assembly defines a litter; and
further comprising:
a base having a head end and a foot end, the base including:
a base frame supporting a plurality of wheels arranged for movement about a floor surface,
an intermediate frame having a trolley configured to translate between a plurality of trolley positions including a trolley forward position where the trolley is arranged at the head end of the base and a trolley docking position where the trolley is arranged at the foot end of the base, and
a base lift device to move the intermediate frame relative to the base frame between a plurality of vertical configurations including a maximum raised configuration and a maximum lowered configuration,
wherein the litter is configured to be docked to and undocked from the trolley of the intermediate frame such that, when docked to the trolley, the litter is configured to slidably translate relative to the intermediate frame between a plurality of litter positions to facilitate docking and undocking the litter from the trolley.

23. (canceled)
